(19) United States
(12) Patent Application Publication
(10) Pub. No.: US 2019/0315486 A1
(43) Pub. Date: Oct. 17, 2019

(54) Adaptive Voxels for Aerial Light Shows

(71) Applicant: QUALCOMM Incorporated, San Diego, CA (US)

(72) Inventors: Paul Daniel MARTIN, Philadelphia, PA (US); Aleksandr KUSHLEYEV, Philadelphia, PA (US); Michael Joshua SHOMIN, Philadelphia, PA (US); Matthew Hyatt TURPIN, Philadelphia, PA (US); Stephen Marc CHAVES, Philadelphia, PA (US); Daniel Warren MELLINGER, III, Philadelphia, PA (US); Ross Eric KESSLER, Philadelphia, PA (US); Moussa Ben COULIBALY, Brookhaven, PA (US)

(21) Appl. No.: 15/953,669

(22) Filed: Apr. 16, 2018

(51) Int. Cl. B64D 47/06; B64C 39/02; G05D 1/10; G08G 5/00; H05B 37/02

(52) U.S. Cl. CPC B64D 47/06; B64C 39/024; G05D 1/104; B64C 2201/024; G08G 5/0069; H05B 37/0272; H05B 37/0227; G08G 5/0034

(57) ABSTRACT

Various methods for providing adaptive voxels for an aerial light show may include determining a physical location of a robotic vehicle with respect to the aerial display, determining an appropriate light emission for the aerial light show based on the physical location of the robotic vehicle with respect to the aerial display, and adjusting a light emission of a light source of the robotic vehicle accordingly.

### BACKGROUND

A number of robotic vehicles, such as unmanned autonomous vehicles (UAV) or drones, may be used to generate an aerial light show. In a typical approach, each robotic vehicle is provided with a flight plan and the robotic vehicle is configured to follow the provided flight plan. Each robotic vehicle illuminates a light of various colors as it follows the corresponding flight plan, thereby generating a visual display within an aerial space. However, if a robotic vehicle is unable to follow the provided flight plan, that robotic vehicle's light will be out of place and the aerial light show will contain a disruption.

### SUMMARY

Various embodiments include methods, and devices and robotic vehicles implementing the methods, of implementing an adaptive voxel by a robotic vehicle within an aerial display. Various embodiments may include a processor of the robotic vehicle determining a physical location of the robotic vehicle with respect to the aerial display, determining an appropriate light emission for the aerial display based on the physical location of the robotic vehicle with respect to the aerial display, and adjusting a light emission of a light source of the robotic vehicle consistent with the determined appropriate light emission.

In some embodiments, determining the physical location of the robotic vehicle with respect to the aerial display may include determining a position of the robotic vehicle within an external coordinate system. In some embodiments, determining the physical location of the robotic vehicle with respect to the aerial display may include determining a viewing angle of the robotic vehicle as seen by an observer.

In some embodiments, determining the physical location of the robotic vehicle with respect to the aerial display may include determining a relative position of the robotic vehicle relative to one or more additional robotic vehicles. In some embodiments, determining the physical location of the robotic vehicle with respect to the aerial display may include determining a viewing angle of the robotic vehicle as seen by an observer.

In some embodiments, determining an appropriate light emission for the aerial display based on the physical location of the robotic vehicle with respect to the aerial display may include obtaining a file comprising information corresponding to at least a portion of the aerial display, mapping the portion of the aerial display onto physical space, and determining the appropriate light emission for the aerial display based on the physical location of the robotic vehicle within the physical space. In some embodiments, obtaining a file comprising information corresponding to at least a portion of the aerial display may include retrieving the file from a memory of the robotic vehicle. In some embodiments, obtaining a file comprising information corresponding to a portion of the aerial display may include receiving the file via wireless communication. In some embodiments, the information corresponding to at least a portion of the aerial display may include the entire aerial display.

In some embodiments, the aerial display may be a frame of a video and the physical location of the robotic vehicle with respect to the aerial display may correspond to a position at a time relative to the frame of the video.

In some embodiments, determining an appropriate light emission for the aerial display based on the physical location of the robotic vehicle with respect to the aerial display may include evaluating a mathematical equation that provides the appropriate light emission based on the physical location of the robotic vehicle.

In some embodiments, adjusting a light emission of the light source of the robotic vehicle may include adjusting one or more of a color of a light source of the robotic vehicle, a brightness of the light source of the robotic vehicle, or an intensity of the light source of the robotic vehicle.

Some embodiments may further include identifying locations of one or more other robotic vehicles with respect to the aerial display, determining whether another robotic vehicle is out of place within the aerial display, and adjusting the physical location of the robotic vehicle based on locations of the one or more other robotic vehicles within the aerial display in response to determining that another robotic vehicle is out of place within the aerial display.

Further embodiments include a robotic vehicle including a processor configured with processor-executable instructions to perform operations of any of the methods summarized above. Further embodiments include a processing device for use within a robotic vehicle in which the processing device is configured to perform operations of any of the methods summarized above. Further embodiments include a non-transitory processor-readable storage medium having stored thereon processor-executable software instructions configured to cause a processor of a robotic vehicle to perform operations of the methods summarized above. Further embodiments include a robotic vehicle that includes means for performing functions of the operations of the methods summarized above.

### BRIEF DESCRIPTION OF THE DRAWINGS

The accompanying drawings, which are incorporated herein and constitute part of this specification, illustrate exemplary embodiments of the claims, and together with the general description and the detailed description given herein, serve to explain the features of the claims.

FIG. 1 is a block diagram illustrating components of a robotic vehicle suitable for use in various embodiments.

FIG. 2A is a block diagram illustrating an aerial display containing out-of-position robotic vehicles.

FIG. 2B is a block diagram illustrating an aerial display containing robotic vehicles performing a method for implementing adaptive voxels, according to various embodiments.

FIG. 3 is a process flow diagram illustrating a method for implementing adaptive voxels by a robotic vehicle according to various embodiments.

FIG. 4 is a process flow diagram illustrating a method for mapping a portion of a visual display onto a physical space, according to various embodiments.

FIG. 5A is a process flow diagram illustrating a method for determining a physical location of a robotic vehicle according to various embodiments.

FIG. 5B is a process flow diagram illustrating an alternate method for determining a physical location of a robotic vehicle according to various embodiments.

FIG. 6 is a process flow diagram illustrating a method for implementing an adaptive voxel by a robotic vehicle according to some embodiments

FIG. 7 is a component block diagram of a robotic vehicle suitable for use with various embodiments.

FIG. 8 is a component block diagram illustrating a processing device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Robotic vehicles, such as drones and UAVs, can be used to implement an aerial light show or display. Robotic vehicles for aerial light shows may carry one or more light sources configured to illuminate in one or more colors, and include communications and sensors (e.g., cameras) and navigation systems for determining physical position. Aerial light shows generated by such robotic vehicles may provide a stunning visual display. However, if one or more of the robotic vehicles are out of position, the visual display will contain disruptions or discrepancies that may degrade the overall impression.

Various embodiments include methods for adjusting the light emitted by an out of position robotic vehicle within an aerial light show or display so that the overall display is not degraded. In various embodiments, a robotic vehicle may be provided with information corresponding to at least a portion of the overall aerial display (instead of just a designated coordinate and a designated light to be emitted). This enables the robotic vehicle to be configured to adapt its light emissions to the actual position of the robotic vehicle so that the light emitted (if any) is consistent with the overall display image. Thus, various embodiments enable robotic vehicles for aerial displays to function as an adaptive voxel, adapting the emitted light (if any) to the actual position of the robotic vehicle, rather that emitting the programmed light regardless of actual position. As used herein, the term “voxel” refers to a single light source in three-dimensional space. The robotic vehicle may map the portion of the aerial display onto a physical space in which the robotic vehicle is operating to determine the appropriate light (e.g., color and brightness if any) to emit. In some embodiments, the robotic vehicle may map the portion of the aerial display onto the physical space by identifying at least one reference point within the physical space and identifying at least one reference point within the portion of the aerial display corresponding to the identified at least one reference point within the physical space.

In various embodiments, as the robotic vehicle participates in the aerial light show, the robotic vehicle may determine the physical location of the vehicle (i.e., the current position of the robotic vehicle) with respect to the aerial display. In some embodiments, a processor may determine the physical location with respect to the aerial display as an absolute position of the robotic vehicle in three-dimensional (3D) space, such as based on a global coordinate system (e.g., latitude, longitude and altitude). In some embodiments, the physical location with respect to the aerial display may be determined as a relative position, such as relative to a landmark on the ground (e.g., the position of the audience), etc. In some embodiments, the relative position may be relative to other robotic vehicles participating in the aerial light show. In various embodiments, the robotic vehicle may use any of a number of sensors or mechanisms for determining a physical location. In some embodiments, the robotic vehicle may determine position based on information provided by a global navigation satellite system (GNSS) receiver, such as a Global Positioning System (GPS) receiver. In some embodiments, the robotic vehicle may utilize an image capture sensor (e.g., a camera) to determine position relative to other robotic vehicles in the display and/or features on the ground.

In various embodiments, the robotic vehicle may use the actual physical or relative location of the robotic vehicle with respect to the aerial display and information in memory regarding the overall aerial display (or a portion thereof) to determine a color light and brightness (if any) that is consistent with the intended aerial display as would be viewed by an intended audience. The robotic vehicle may then adjust the light that is emitted (if any) accordingly. Various embodiments thus enable a robotic vehicle to implement an adaptive voxel that may minimize disruptions to or discrepancies within an aerial light show when the robotic vehicle is out of position. For example, if a robotic vehicle maneuvering to a location where blue light is to be emitted determines that it is currently within a region of space where other robotic vehicles are emitting white light, the robotic vehicle may instead emit a white light and continue to do so until it reaches a region of space where robotic vehicles are emitting another color or no light. This enables robotic vehicles that are at least temporarily out of position to participate in the aerial display without impacting the overall impression on the audience.

In some embodiments, the robotic vehicle may obtain the information corresponding to at least a portion of the aerial display by retrieving the information from a memory of the robotic vehicle. In some embodiments, the robotic vehicle may obtain the information corresponding to at least a portion of the aerial display by receiving the information via wireless communications. Such information may be in the form of a grid data file or diagram that encompasses regions of space in which all robotic vehicles are operating indicating the colors and intensities of light to be implemented in various 3D regions of space at specific times, rather than a single 3D location. In some embodiments, such information may be the assigned position of all robotic vehicles operating in the aerial display, which may enable each robotic vehicle to determine an appropriate light to emit (i.e., adaptive voxel) based on the lights to be emitted by nearby robotic vehicles.

Aerial displays may be two-dimensional displays or three-dimensional displays when viewed by an audience. To generate an aerial display, robotic vehicles are programmed to fly to a particular point in space, as may be defined by three coordinates (e.g., latitude, longitude and altitude). The locations of each robotic vehicle may be determined by a display designer so that when viewed from a target audience at a removed location (e.g., below or at a distance), the light emitted by the robotic vehicles (i.e. the voxels) results in a viewable image. Thus, a designer may select an overall image that the target audience will see as the aerial display, and then translate that image into a number of voxels that indicates the 3D coordinates and type of the emitted light for each robotic vehicle that will result in the desired image presentation. While conventional aerial displays are designed by identifying the individual locations of each light-emitting robotic vehicle as a function of time, and thus controlling the position of each voxel, various embodiments enable aerial displays to be designed in terms of regions of space within which individual robotic vehicles will operate.

In various embodiments, the robotic vehicle may participate in the aerial display based on a provided flight plan that specifies the 3D coordinates and light emissions (e.g., color and/or brightness) that each robotic vehicle should achieve as a function of time. The robotic vehicle may also be provided with additional information about the aerial display. While following the provided flight plan, the robotic vehicle may identify one or more nearby robotic vehicles participating in the aerial display. In some embodiments, the robotic vehicle may determine a variance between the robotic vehicle's physical location and the assigned location based on the provided flight plan. The robotic vehicle may also determine variations between estimated physical locations of the nearby robotic vehicles and their assigned locations. Based on the determined positional variances, the robotic vehicle may modify the provided flight plan and adjust the emitted light (if any) based on the modified flight plan. For example, the robotic vehicle may move to “fill in a gap” in the aerial display caused by another robotic vehicle being out of position.

In some embodiments, a perpetual or otherwise long-lasting display may be enabled by robotic vehicles transitioning into and out of the aerial display. In a perpetual display, as one or more robotic vehicles join the aerial display and begin light emissions based on location, one or more other robotic vehicles may stop emitting light and exit the display, such as to recharge. For example, a robotic vehicle may join an aerial display at an edge (e.g., a left or right side edge and/or a top or bottom edge) and move through the aerial display (e.g., horizontally, vertically, or both), with the processor adjusting light emissions (e.g., color and/or brightness) based on the current location of the robotic vehicle. As another example, the robotic vehicles may be organized in columns with each robotic vehicle moving horizontally with light emissions adjusted based on position so that as a column reaches an edge (e.g., right edge), the lights emitted by robotic vehicles in the column stop light emissions while a new column of robotic vehicles join the aerial display on the opposite edge (e.g., left edge) and begin emitting light. When a robotic vehicle reaches an edge of the aerial display or a battery of the robotic vehicle has been depleted, the processor may stop light emissions so that the robotic vehicle can stop participating in the aerial display (e.g., cease light emissions), such as to proceed to a landing location. In this way, robotic vehicles may transition into and out of an aerial display without disruption to the aerial display. In other words, the moving robotic vehicles within the perpetual display may adjust light emissions based on their respective positions so that the aerial display appears static while permitting robotic vehicles to exit the display for recharging.

As used herein, the term “robotic vehicle” refers to one of various types of aerial vehicles including an onboard computing device configured to provide some autonomous or semi-autonomous capabilities. Robotic vehicles may be winged aircraft or rotorcraft (also referred to as a multirotor or multicopter) that include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors.

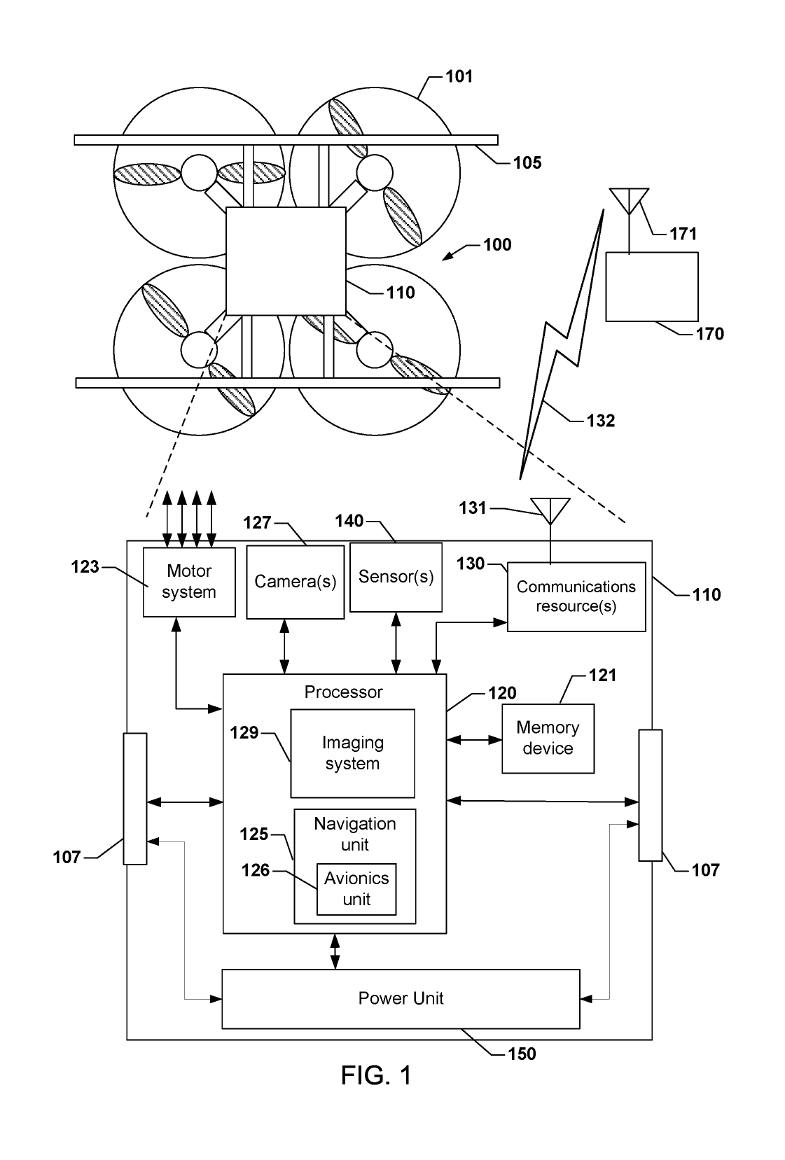

FIG. 1 illustrates an example aerial robotic vehicle 100 suitable for use with various embodiments. The example robotic vehicle 100 is a “quad copter” having four horizontally configured rotary lift propellers, or rotors 101 and motors fixed to a frame 105. The frame 105 may support a control unit 110, landing skids and the propulsion motors, power source (power unit 150) (e.g., battery), light sources 107 (e.g., light emitting diodes (LEDs), incandescent lights, lasers, etc.), and other components. Land-based and waterborne robotic vehicles may include compliments similar to those illustrated in FIG. 1.

The robotic vehicle 100 may be provided with a control unit 110. The control unit 110 may include a processor 120, communication resource(s) 130, sensor(s) 140, and a power unit 150. The processor 120 may be coupled to a memory unit 121 and a navigation unit 125. The processor 120 may be configured with processor-executable instructions to control flight and other operations of the robotic vehicle 100, including operations of various embodiments. In some embodiments, the processor 120 may be coupled to the various light sources 107. The processor 120 may be powered from the power unit 150, such as a battery. The processor 120 may be configured with processor-executable instructions to control the charging of the power unit 150, such as by executing a charging control algorithm using a charge control circuit. Alternatively or additionally, the power unit 150 may be configured to manage charging. The processor 120 may be coupled to a motor system 123 that is configured to manage the motors that drive the rotors 101. The motor system 123 may include one or more propeller drivers. Each of the propeller drivers includes a motor, a motor shaft, and a propeller.

Through control of the individual motors of the rotors 101, the robotic vehicle 100 may be controlled in flight. In the processor 120, a navigation unit 125 may collect data and determine the present position and orientation of the robotic vehicle 100, the appropriate course towards an assigned 3D location, and/or the best way to perform a particular function.

An avionics component 126 of the navigation unit 125 may be configured to provide flight control-related information, such as altitude, attitude, airspeed, heading and similar information that may be used for navigation purposes. The avionics component 126 may also provide data regarding the orientation and accelerations of the robotic vehicle 100 that may be used in navigation calculations. In some embodiments, the information generated by the navigation unit 125, including the avionics component 126, depends on the capabilities and types of sensor(s) 140 on the robotic vehicle 100.

The control unit 110 may include one or more navigation sensors 140 coupled to the processor 120, which can supply data to the navigation unit 125 and/or the avionics component 126. For example, the navigation sensor(s) 140 may include inertial sensors, such as one or more accelerometers (providing motion sensing readings), one or more gyroscopes (providing rotation sensing readings), one or more magnetometers (providing direction sensing), or any combination thereof. The navigation sensor(s) 140 may also include a GNSS/GPS receiver, barometers, thermometers, audio sensors, motion sensors, cameras, etc. Inertial sensors may provide navigational information, e.g., via dead reckoning, including at least one of the position, orientation, and velocity (e.g., direction and speed of movement) of the robotic vehicle 100. A barometer may provide ambient pressure readings used to approximate elevation level (e.g., absolute elevation level) of the robotic vehicle 100.

The terms GPS and GNSS receivers are used interchangeably herein to refer to any of a variety of satellite-aided navigation systems, such as GPS deployed by the United States, GLObal NAvigation Satellite System (GLONASS) used by the Russian military, and Galileo for civilian use in the European Union, as well as terrestrial communication systems that augment satellite-based navigation signals or provide independent navigation information. GPS and GNSS receivers can provide the robotic vehicle 100 with an accurate position in terms of latitude, longitude, and altitude, and by monitoring changes in position over time, the navigation unit 125 can determine direction of travel and speed over the ground as well as a rate of change in altitude. In some embodiments, the navigation unit 125 may use an additional or alternate source of positioning signals other than GNSS or GPS.

In some embodiments, the communication resource(s) 130 may support 3D navigation receiving navigation beacons or other signals from various radio nodes, such as navigation beacons (e.g., very high frequency (VHF) omnidirectional range (VOR) beacons), Wi-Fi access points, cellular network sites, radio stations, etc. In some embodiments, the navigation unit 125 of the processor 120 may be configured to receive information suitable for determining position from the communication resources(s) 130.

In some embodiments, the robotic vehicle 100 may use an alternate source of positioning signals (i.e., other than GNSS, GPS, etc.). Because robotic vehicles performing an aerial display often fly at low altitudes (e.g., below 400 feet), the robotic vehicle 100 may scan for local radio signals (e.g., Wi-Fi signals, Bluetooth signals, cellular signals, etc.) associated with transmitters (e.g., beacons, Wi-Fi access points, Bluetooth beacons, small cells (picocells, femtocells, etc.), etc.) having known locations, such as beacons or other signal sources deployed to enhance navigation of the robotic vehicles performing the aerial display. The navigation unit 125 may use location information associated with the source of the alternate signals together with additional information (e.g., dead reckoning in combination with last trusted GNSS/GPS location, dead reckoning in combination with a position of the robotic vehicle takeoff zone, etc.) for positioning and navigation in some applications. Thus, the robotic vehicle 100 may navigate using a combination of navigation techniques, including dead-reckoning, camera-based recognition of the land features below and around the robotic vehicle 100 (e.g., recognizing a building, landmarks, streetlights, etc.), etc. that may be used instead of or in combination with GNSS/GPS location determination and triangulation or trilateration based on known locations of detected wireless access points.

In some embodiments, the control unit 110 may include a camera 127 and an imaging system 129. The imaging system 129 may be implemented as part of the processor 120, or may be implemented as a separate processor, such as an application-specific integrated circuit (ASIC), a field programmable gate array (FPGA), or other logical circuitry. For example, the imaging system 129 may be implemented as a set of executable instructions stored in the memory unit 121 that execute on the processor 120 coupled to the camera 127. The camera 127 may include sub-components other than image or video capturing sensors, including auto-focusing circuitry, International Organization for Standardization (ISO) adjustment circuitry, and shutter speed adjustment circuitry, etc. For example, images from a camera 127 may be used for determining relative position with respect to other robotic vehicles in the aerial display.

The control unit 110 may include one or more communication resources 130, which may be coupled to at least one transmit/receive antenna 131 and include one or more transceivers. The transceiver(s) may include any of modulators, de-modulators, encoders, decoders, encryption modules, decryption modules, amplifiers, and filters. The communication resource(s) 130 may be capable of device-to-device and/or cellular communication with other robotic vehicles, wireless communication devices carried by a user (e.g., a smartphone), a robotic vehicle controller, and other devices or electronic systems (e.g., a vehicle electronic system).

The processor 120 and/or the navigation unit 125 may be configured to communicate through the communication resource(s) 130 with a wireless communication device 170 through a wireless connection (e.g., a cellular data network) to receive assistance data from the server and to provide robotic vehicle position information and/or other information to the server.

A bi-directional wireless communication link 132 may be established between transmit/receive antenna 131 of the communication resource(s) 130 and the transmit/receive antenna 171 of the wireless communication device 170. In some embodiments, the wireless communication device 170 and robotic vehicle 100 may communicate through an intermediate communication link, such as one or more wireless network nodes or other communication devices. For example, the wireless communication device 170 may be connected to the communication resource(s) 130 of the robotic vehicle 100 through a cellular network base station or cell tower. Additionally, the wireless communication device 170 may communicate with the communication resource(s) 130 of the robotic vehicle 100 through a local wireless access node (e.g., a WiFi access point) or through a data connection established in a cellular network. In some embodiments, wireless communication links may be used to upload information regarding the overall images to be rendered in an aerial display.

While the various components of the control unit 110 are illustrated in FIG. 1 as separate components, some or all of the components (e.g., the processor 120, the motor system 123, the communication resource(s) 130, and other units) may be integrated together in a single device or unit, such as a system-on-chip. The robotic vehicle 100 and the control unit 110 may also include other components not illustrated in FIG. 1.

Various embodiments include a robotic vehicle configured to determine a physical location of the robotic vehicle within 3D space, determine an appropriate light to be emitted consistent with the robotic vehicle's position within visual display, and adjust a light emission (i.e., color and/or intensity of emitted light) of the robotic vehicle consistent with the current location in the overall aerial display.

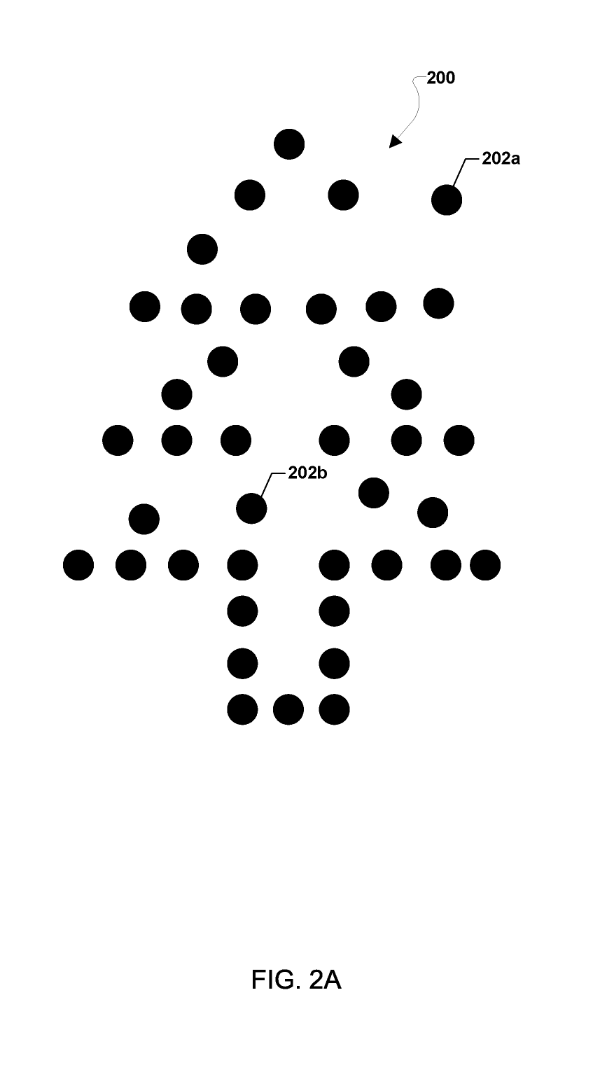

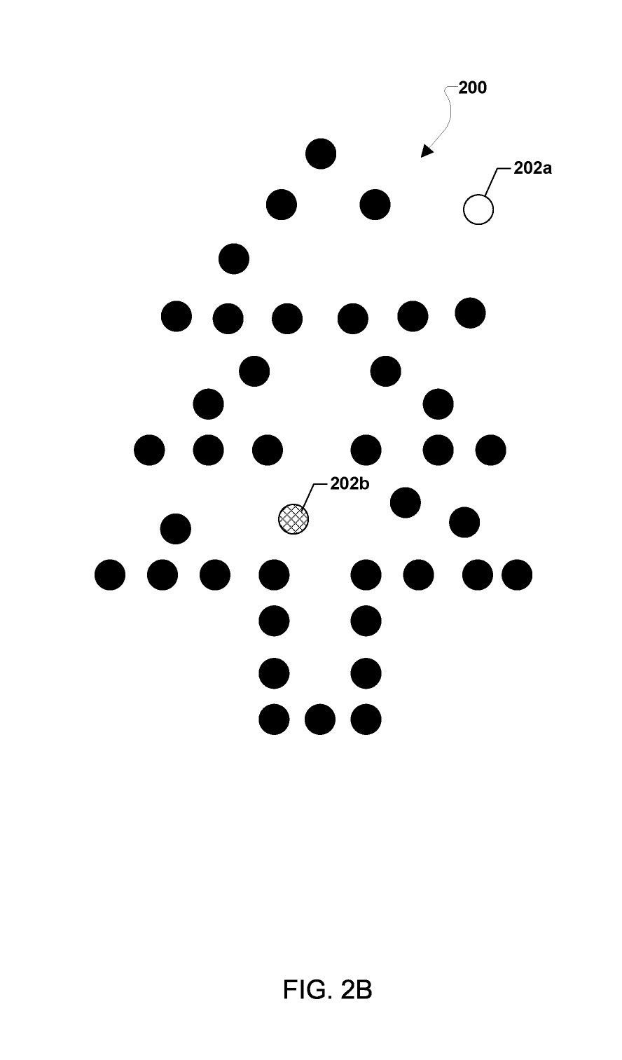

FIG. 2A illustrates a swarm of robotic vehicles 200 performing an aerial display when viewed from underneath. The illustrated example aerial display represents a Christmas tree. However, robotic vehicles 202a, 202b are out of position. As such, the aerial display contains disruptions or discrepancies.

FIG. 2B illustrates a swarm of robotic vehicles 200 performing an aerial display while implementing adaptive voxels according to various embodiments. In the illustrated example, robotic vehicle 202a has determined that it is located outside the aerial display and adjusted its light emission so that it is not admitting any light. Similarly, robotic vehicle 202b has determined that it is located in an interior portion of the tree and adjusted its light emission so that it emits light consistent with the determined physical location, such as part of an ornament. Thus, although robotic vehicles 202a, 202b are out of their desired position, the aerial display does not contain disruptions or discrepancies.

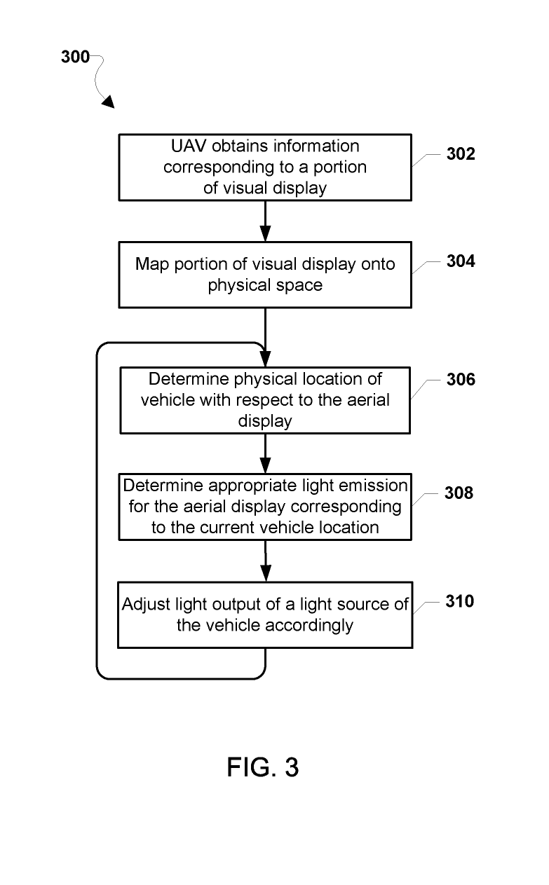

FIG. 3 illustrates a method 300 for implementing an adaptive voxel by a robotic vehicle according to various embodiments. With reference to FIGS. 1-3, the operations of the method 300 may be performed by a processor (e.g., the processor 120) of a robotic vehicle (e.g., 100). The robotic vehicle may have navigation sensors (e.g., 140), cameras (e.g., 127), and communication resources (e.g., 130) that may be used for determining a physical location. The robotic vehicle may also include various light sources (e.g., 107), which may be configured to emit different colors of light at various levels of intensity.

In block 302, the robotic vehicle processor may obtain information corresponding to at least a portion of a visual display. For example, the processor may obtain database, image or video file containing information defining the aerial display to be produced. The information may represent only a part of the entire aerial display in which the robotic vehicle will be operating. Alternatively, the information may encompass or represent the entire aerial display. In this way, the robotic vehicle processor has information pertaining to more than just the robotic vehicle's own flight plan. In some embodiments, the robotic vehicle processor may obtain the information by retrieving the information from a memory of the robotic vehicle. In some embodiments, the robotic vehicle processor may receive the information via wireless communications.

In block 304, the robotic vehicle processor may map the portion of the aerial display onto a physical space. Any of a variety of methods may be used for this mapping. In some embodiments, the processor may identify a reference point in physical space and a reference point in the portion of the aerial display that corresponds to the identified reference point in physical space. In this way, robotic vehicle processor may correlate the aerial display information to the physical 3D space within which the aerial display is to be rendered. This operation may enable a general display file to be stored in memory for use in any of a variety of geographic locations, and then correlated to the location in which the aerial display is to be presented. For example, relative coordinates within a general display file may be correlated to specific GPS or geographic coordinates (e.g., latitude, longitude, altitude) encompassing the airspace within which aerial display will be performed.

In block 306, the processor may determine the physical location of the robotic vehicle with respect to the aerial display while the aerial display is being performed. In some embodiments, the physical location of the robotic vehicle may be determined in terms of the coordinates used to map the image to be presented in the aerial display onto the physical space in block 304 (e.g., GPS or geographic coordinates). The processor may use a variety of navigational techniques to determine a current location of the robotic vehicle, including GPS in combination with dead reckoning. In various embodiments, the physical location may be an absolute location, a relative location, and/or a combination of an absolute location and a relative location. In some embodiments, the relative location may be relative to one or more nearby robotic vehicles performing the aerial show. In various embodiments, the physical location may include a viewing angle of the robotic vehicle as seen by an observer of the aerial show. In some embodiments, the processor may determine the physical location of the robotic vehicle with respect to the aerial display in block 306 as part of navigating to an assigned position according to a preloaded flight plan.

In block 308, the processor may determine an appropriate light emission within the aerial display that corresponds to the current location of the robotic vehicle with respect to the aerial display. For example, the robotic vehicle may identify where in the aerial display the robotic vehicle is currently located (e.g., identify a location within a raster image), and determine the color and intensity of light (if any) that would be consistent with the current location within the aerial display (e.g., lookup light emissions corresponding to the raster image location). In another example, the robotic vehicle may calculate an appropriate light emission by evaluating a mathematical equation that provides the appropriate light emission based on the current location (e.g., calculate a vector value that identifies the appropriate light emissions). In instances in which the robotic vehicle is at the assigned position according to the flight plan, the appropriate light emission may be the light emission designated in the preloaded flight plan.

In block 310, the processor may adjust the light output of the robotic vehicle light source (e.g., 107) accordingly, that is consistent with the appropriate light emission corresponding to the current location of the robotic vehicle within or with respect to the aerial display determined in block 308. For example, in some embodiments the processor may select an appropriate color light to emit and adjust the intensity of the emitted light. In various embodiments, the processor of the robotic vehicle may adjust either or both of emitted color and brightness or intensity. The robotic vehicle may have a single light source or multiple light sources. In some embodiments, the processor may adjust each light source in a different fashion (e.g., increase brightness of light source one while decreasing brightness of light source two) or may adjust all light sources in a similar fashion (e.g., change all light sources to output a blue color).

The operations in blocks 306-310 may be performed continuously by a processor so long as the robotic vehicle is involved in the aerial display. Some embodiments may further include maneuvering the robotic vehicle to new positions while performing operations in blocks 306-310, either incrementally or continuously. For example, in a perpetual aerial display, the processor of a robotic vehicles may begin performing operations in blocks 306-310 and continue to do so while moving through the volume of the display, and eventually ceasing light emissions in block 310 upon leaving the volume of the display.

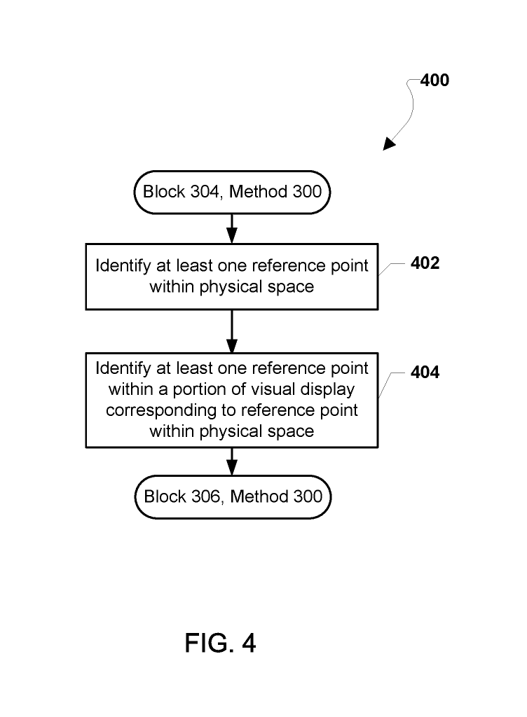

FIG. 4 illustrates a method 400 for mapping a portion of a visual display onto a physical space according to some embodiments. With reference to FIGS. 1-4, the method 400 provides an example of operations that may be performed in block 304 of the method 300. The operations of the method 400 may be performed by a processor (e.g., the processor 120) of a robotic vehicle (e.g., the robotic vehicle 100).

In block 402, the processor may identify at least one reference point within the physical space in the vicinity of where the aerial display will be performed. For example, the processor may use any of a number of navigational techniques to identify at least one physical reference point, such as a corner of the physical space in which the aerial show is to be performed.

In block 404, the processor may identify at least one reference point within a portion of a visual display that corresponds to the identified physical reference point. For example, if the processor identifies one corner of the physical space as a physical reference point (e.g., top left corner of physical space), the processor may identify a corner of the visual display corresponding to the identified corner of the physical space (e.g., top left corner of visual display). In this way, given a physical location of the robotic vehicle, a corresponding visual location within the visual display may also be determined based on relations of the physical location and the visual location to the physical reference point(s) and the visual reference point(s). The processor may then proceed with the operations of block 306 of the method 300 as described.

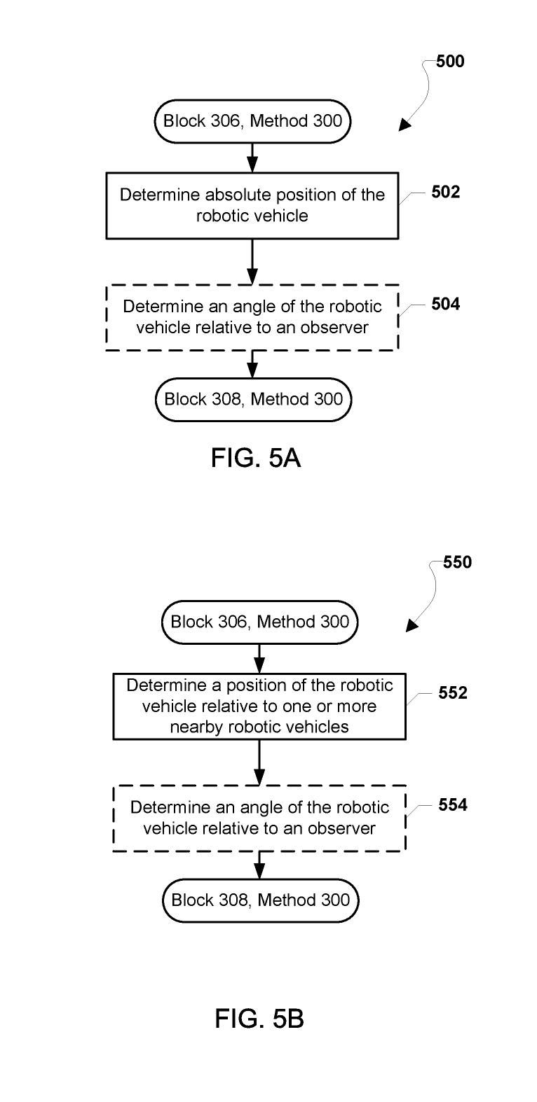

FIGS. 5A-5B illustrate methods 500 and 550 for determining a physical location of a robotic vehicle according to various embodiments. With reference to FIGS. 1-5B, the methods 500 and 550 provide examples of operations that may be performed in block 306 of the method 300. The operations of the methods 500 and 550 may be performed by a processor (e.g., the processor 120) of a robotic vehicle (e.g., the robotic vehicle 100). The method 500 is for determining a physical location of a robotic vehicle in which an absolute position of the robotic vehicle is determined. The method 550 is for determining a physical location of a robotic vehicle in which a relative position of the robotic vehicle is determined.

Referring to the method 500, the processor may determine an absolute position of the robotic vehicle in block 502. As used herein, the term “absolute position” refers to a position within an external coordinate system, such as within a geographic coordinates system (e.g., latitude, longitude, altitude), as may be provided by a GPS receiver. The processor may utilize any of a number of navigational approaches to determine the position of the robotic vehicle. In some embodiments, the processor may utilize a GPS receiver, an accelerometer, a gyroscope, and/or any other sensor to determine the absolute position of the robotic vehicle.

In optional block 504, the processor may determine a viewing angle of the robotic vehicle as seen by an observer, such as an individual standing on the ground watching the aerial light show. In some embodiments, a robotic vehicle may include multiple light sources. In such embodiments, the processor may control each light source in a different way depending on viewing angles of each light source as seen by the observer. In this way, an aerial show may appear the same regardless of from where the show is observed. Alternatively, or in addition, an aerial show may present differing images depending on from where the show is observed. The processor may then proceed with the operations of block 308 of the method 300 as described.

Referring to the method 550, the processor may determine a relative position of the robotic vehicle in block 552. In various embodiments, the relative position of the robotic vehicle may be relative to one or more additional robotic vehicles (e.g., other robotic vehicles performing an aerial show). For example, the processor may control a camera (e.g., 127) or video camera of the robotic vehicle to capture one or more images of other robotic vehicles. Alternatively, or in addition, the processor may utilize communications resources of the robotic vehicle to exchange communications with one or more other robotic vehicles.

In optional block 554, the processor may determine a viewing angle of the robotic vehicle as seen by an observer (e.g., in an observer in a target audience), such as an individual standing on the ground watching the aerial light show. In various embodiments, a robotic vehicle may include multiple light sources (e.g. 107). In such embodiments, the processor may control each light source in a different way depending on the viewing angles of each light source relative to an observer. In this way, an aerial show may appear the same regardless of from where the show is observed. Alternatively or in addition, an aerial show may present differing images depending the viewing angle. The processor may then proceed with the operations of block 308 of the method 300 as described.

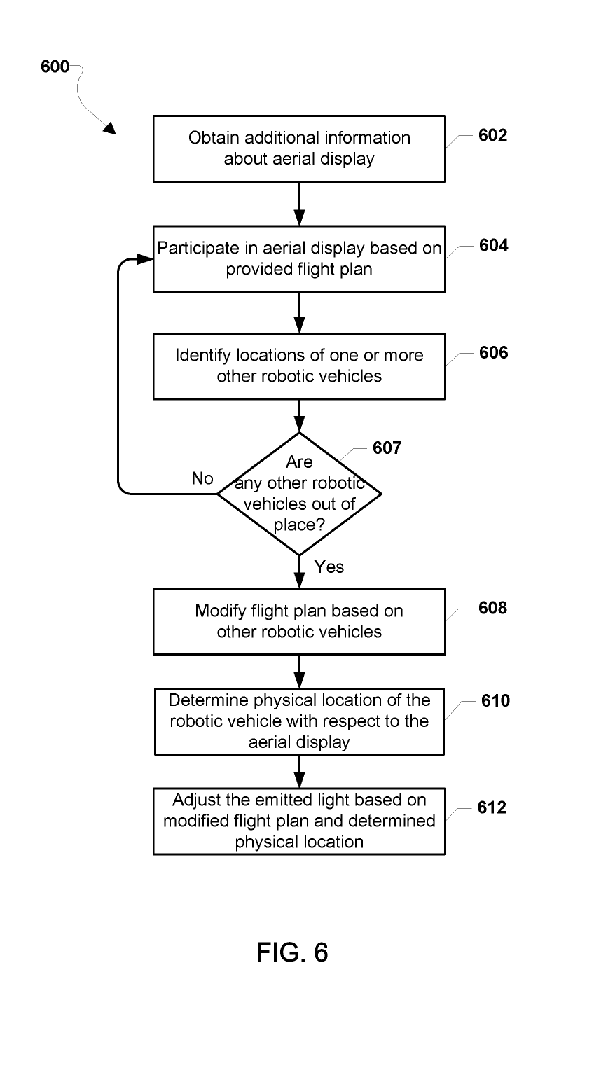

FIG. 6 illustrates a method 600 for participating in an aerial light show by a robotic vehicle according to some embodiments. With reference to FIGS. 1-6, the operations of the method 600 may be performed by one or more processors (e.g., the processor 120) of a robotic vehicle (e.g., 100). The robotic vehicle may have sensors (e.g., 140), cameras (e.g., 127), and communication resources (e.g., 130) that may be used determining a physical location, and the processor may be configured to modify a flight plan of the robotic vehicle and adjust a light source (e.g., 107) of the robotic vehicle based on the modified flight plan.

In block 602, the robotic vehicle may obtain additional information about the aerial display. For example, the robotic vehicle may obtain an image or video file containing information defining the aerial display to be produced. The information may represent only a part of the entire aerial display or the information may represent the entire aerial display. In this way, the robotic vehicle has information pertaining to more than just the robotic vehicle's own flight plan. In some embodiments, the robotic vehicle may obtain the information by retrieving the information from a memory of the robotic vehicle. In some embodiments, the robotic vehicle may receive the information via wireless communications.

In block 604, the processor may control a robotic vehicle to participate in an aerial display based on a provided flight plan. In various embodiments, the flight plan may be provided prior to commencement of the aerial display and/or prior to participation in the aerial display by the robotic vehicle. In some embodiments, the provided flight plan may define one or more desired positions for the robotic vehicle to achieve during or throughout the aerial display. In addition, the flight plan may also define a desired light emission to be produced by the robotic vehicle at each of the desired positions.

In block 606, the processor may identify locations of one or more other robotic vehicles participating in the aerial display. For example, the processor may control a camera of the robotic vehicle to acquire one or more images and the processor may be configured to perform image processing to identify other robotic vehicles within the captured images. Alternatively or in addition, the processor may utilize a communication resource to exchange coordinate information with other robotic vehicles participating in the aerial display.

In determination block 607, the processor may determine whether any other robotic vehicles within the aerial display are out of place or otherwise “missing”. The processor may accomplish this by comparing the locations of the other robotic vehicles to the assigned locations for the other robotic vehicles within the aerial display. In in this manner, robotic vehicles that are out of place or “missing” from the aerial display may be identified. For example, the processor may expect an additional robotic vehicle to be proximate and failure to identify such additional robotic vehicle may indicate that such additional robotic vehicle has failed and/or is otherwise not successfully participating in the aerial display.

In response to determining that there are no other robotic vehicles out of place (i.e., determination block 607=“No”), the processor may continue executing the flight plan to participate in the aerial display in block 600 for as described.

In response to determining that another robotic vehicle is out of place (i.e., determination block 607=“Yes”), the processor may modify the flight plan of the robotic vehicle based on the information on the aerial display and the missing or out of place robotic vehicles in block 608. For example, when the processor determines that one or more of the identified nearby robotic vehicles are out of position or that an additional robotic vehicle is “missing,” the processor may modify the flight plan so as to “fill in the gap” within the aerial display.

In block 610, the processor of the robotic vehicle may determine the physical location of the robotic vehicle with respect to the aerial display using any of various methods as described.

In block 612, the processor may control the robotic vehicle to adjust a light emission of a light source of the robotic vehicle based on the modified flight plan and the determined physical location of the robotic vehicle with respect to the aerial display. For example, in some embodiments the processor of the robotic vehicle may adjust an output of a light source (e.g., 107) of the robotic vehicle. In various embodiments, the processor of the robotic vehicle may adjust one or more of a color output, a brightness, or an intensity. In some embodiments, the robotic vehicle may have a single light source. In other embodiments, the robotic vehicle may have multiple light sources. In such other embodiments, the processor of the robotic vehicle may adjust each light source in a different fashion (e.g., increase brightness of light source one while decreasing brightness of light source two) or may adjust all light sources in a similar fashion (e.g., change all light sources to output a blue color). Thus, the method 600 enables a robotic vehicle to implement an adaptive voxel based on a current location of the robotic vehicle as well as locations of other robotic vehicles within the aerial display.

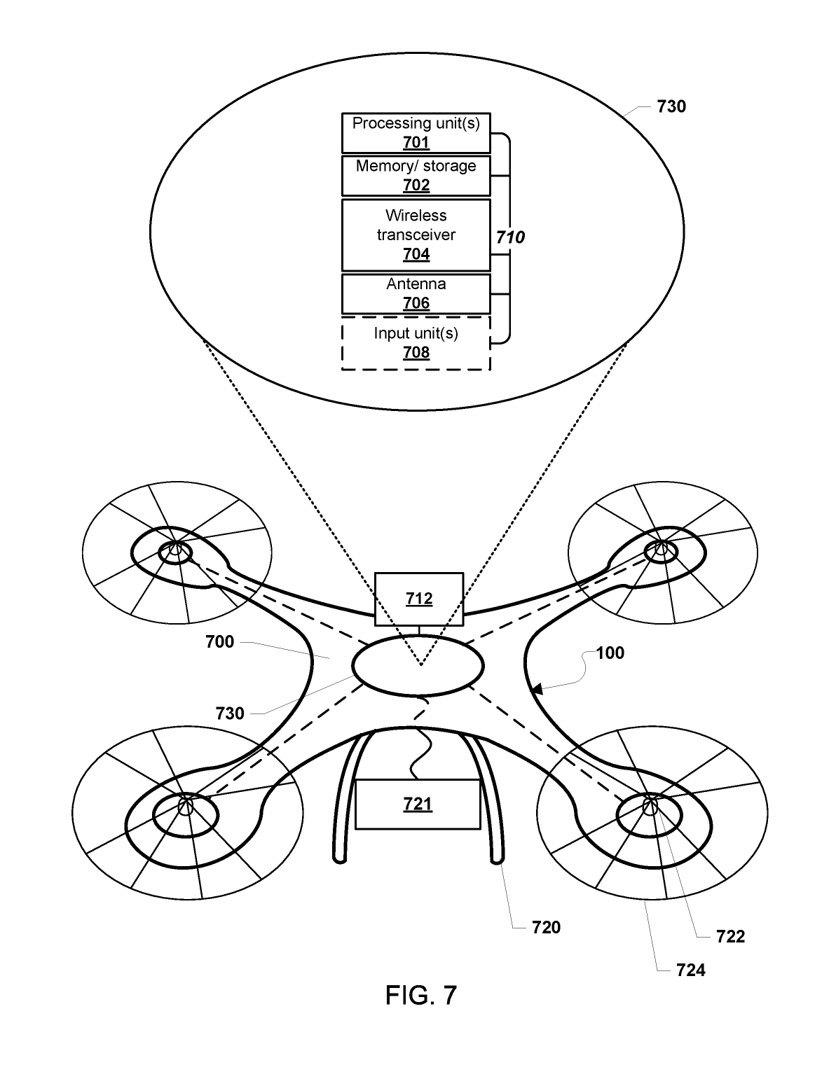

Various embodiments may be implemented within a variety of robotic vehicles, an example of which in the form of a four-rotor UAV is illustrated in FIG. 7 that is suitable for use with various embodiments. With reference to FIGS. 1-7, the robotic vehicle 100 may include a body 700 (i.e., fuselage, frame, etc.) that may be made out of any combination of plastic, metal, or other materials suitable for flight. The body 700 may include a processor 730 that is configured to monitor and control the various functionalities, subsystems, and/or other components of the robotic vehicle 100. For example, the processor 730 may be configured to monitor and control various functionalities of the robotic vehicle 100, such as any combination of modules, software, instructions, circuitry, hardware, etc. related to propulsion, navigation, power management, sensor management, and/or stability management.

The processor 730 may include one or more processing unit(s) 701, such as one or more processors configured to execute processor-executable instructions (e.g., applications, routines, scripts, instruction sets, etc.), a memory and/or storage unit 702 configured to store data (e.g., flight plans, obtained sensor data, received messages, applications, etc.), and a wireless transceiver 704 and antenna 706 for transmitting and receiving wireless signals (e.g., a Wi-Fi® radio and antenna, Bluetooth®, RF, etc.). In some embodiments, the robotic vehicle 100 may also include components for communicating via various wide area networks, such as cellular network transceivers or chips and associated antenna (not shown). In some embodiments, the processor 730 of the robotic vehicle 100 may further include various input units 708 for receiving data from human operators and/or for collecting data indicating various conditions relevant to the robotic vehicle 100. For example, the input units 708 may include camera(s), microphone(s), location information functionalities (e.g., a global positioning system (GPS) receiver for receiving GPS coordinates), flight instruments (e.g., attitude indicator(s), gyroscope(s), accelerometer(s), altimeter(s), compass(es), etc.), keypad(s), etc. The various components of the processor 730 may be connected via a bus 710 or another similar circuitry.

The body 700 may include landing gear 720 of various designs and purposes, such as legs, skis, wheels, pontoons, etc. The body 700 may also include a light source 721 configured to emit light of various colors and/or intensities. For example, the light source 721 may be an array LEDs configured to emit light of different wavelengths.

The robotic vehicle 100 may be of a helicopter design that utilizes one or more rotors 724 driven by corresponding motors 722 to provide lift-off (or take-off) as well as other aerial movements (e.g., forward progression, ascension, descending, lateral movements, tilting, rotating, etc.). The robotic vehicle 100 may utilize various motors 722 and corresponding rotors 724 for lifting off and providing aerial propulsion. For example, the robotic vehicle 100 may be a “quad-copter” that is equipped with four motors 722 and corresponding rotors 724. The motors 722 may be coupled to the processor 730 and thus may be configured to receive operating instructions or signals from the processor 730. For example, the motors 722 may be configured to increase rotation speed of their corresponding rotors 724, etc. based on instructions received from the processor 730. In some embodiments, the motors 722 may be independently controlled by the processor 730 such that some rotors 724 may be engaged at different speeds, using different amounts of power, and/or providing different levels of output for moving the robotic vehicle 100. For example, motors 722 on one side of the body 700 may be configured to cause their corresponding rotors 724 to spin at higher rotations per minute (RPM) than rotors 724 on the opposite side of the body 700 in order to balance the robotic vehicle 100 burdened with an off-centered payload.

The body 700 may include a power source 712 that may be coupled to and configured to power the various other components of the robotic vehicle 100. For example, the power source 712 may be a rechargeable battery for providing power to operate the motors 722, the light source 721, and/or the units of the processor 730.

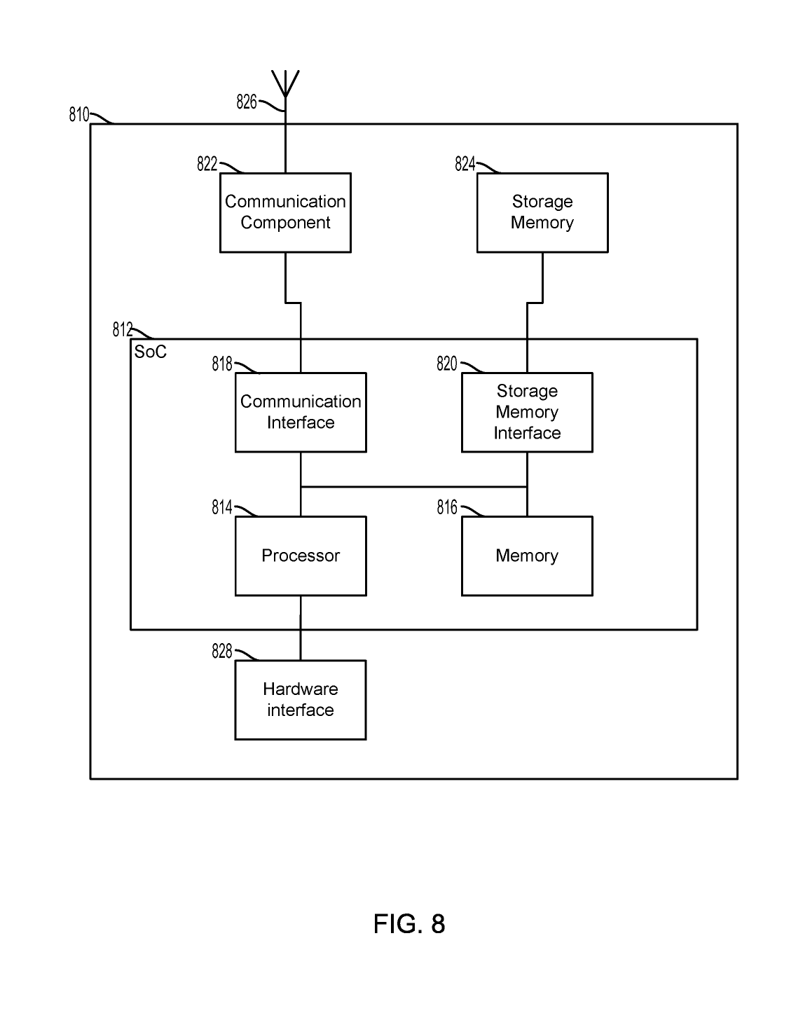

FIG. 8 is a component block diagram illustrating a processing device suitable for implementing various embodiments.

Various embodiments may be implemented within a processing device 810 configured to be used in a robotic vehicle. A processing device may be configured as or including a system-on-chip (SOC) 812, an example of which is illustrated FIG. 8. With reference to FIGS. 1-8, the SOC 812 may include (but is not limited to) a processor 814, a memory 816, a communication interface 818, and a storage memory interface 820. The processing device 810 or the SOC 812 may further include a communication component 822, such as a wired or wireless modem, a storage memory 824, an antenna 826 for establishing a wireless communication link, and/or the like. The processing device 810 or the SOC 812 may further include a hardware interface 828 configured to enable the processor 814 to communicate with and control various components of a robotic vehicle. The processor 814 may include any of a variety of processing devices, for example any number of processor cores.

The term “system-on-chip” (SoC) is used herein to refer to a set of interconnected electronic circuits typically, but not exclusively, including one or more processors (e.g., 814), a memory (e.g., 816), and a communication interface (e.g., 818). The SOC 812 may include a variety of different types of processors 814 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SOC 812 may further embody other hardware and hardware combinations, such as a field programmable gate array (FPGA), an ASIC, other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 812 may include one or more processors 814. The processing device 810 may include more than one SoC 812, thereby increasing the number of processors 814 and processor cores. The processing device 810 may also include processors 814 that are not associated with an SoC 812 (i.e., external to the SoC 812). Individual processors 814 may be multicore processors. The processors 814 may each be configured for specific purposes that may be the same as or different from other processors 814 of the processing device 810 or SOC 812. One or more of the processors 814 and processor cores of the same or different configurations may be grouped together. A group of processors 814 or processor cores may be referred to as a multi-processor cluster.

The memory 816 of the SoC 812 may be a volatile or non-volatile memory configured for storing data and processor-executable instructions for access by the processor 814. The processing device 810 and/or SoC 812 may include one or more memories 816 configured for various purposes. One or more memories 816 may include volatile memories such as random access memory (RAM) or main memory, or cache memory.

Some or all of the components of the processing device 810 and the SOC 812 may be arranged differently and/or combined while still serving the functions of the various aspects. The processing device 810 and the SOC 812 may not be limited to one of each of the components, and multiple instances of each component may be included in various configurations of the processing device 810.

The various processors described herein may be any programmable microprocessor, microcomputer or multiple processor chip or chips that can be configured by software instructions (applications) to perform a variety of functions, including the functions of various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, any block(s) of the method 600 may be incorporated into any one of the methods 200/300/400/500 and vice versa.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, compact disc ROM (CD-ROM) or other optical disk storage, magnetic disk storage or other magnetic storage smart objects, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method for controlling light emission of a robotic vehicle performing an aerial display, comprising:
determining, by a processor of the robotic vehicle, a physical location of the robotic vehicle with respect to the aerial display;
determining, by a processor, an appropriate light emission for the aerial display based on the physical location of the robotic vehicle with respect to the aerial display; and
adjusting, by a processor, a light emission of a light source of the robotic vehicle consistent with the determined appropriate light emission.

2. The method of claim 1, wherein determining the physical location of the robotic vehicle with respect to the aerial display comprises determining a position of the robotic vehicle within an external coordinate system.

3. The method of claim 1, wherein determining the physical location of the robotic vehicle with respect to the aerial display further comprises determining within an external coordinate system and a viewing angle of the robotic vehicle as seen by an observer.

4. The method of claim 1, wherein determining the physical location of the robotic vehicle with respect to the aerial display comprises determining a relative position of the robotic vehicle relative to one or more other robotic vehicles.

5. The method of claim 1, wherein determining the physical location of the robotic vehicle with respect to the aerial display comprises determining a relative position of the robotic vehicle relative to one or more other robotic vehicles and a viewing angle of the robotic vehicle as seen by an observer.

6. The method of claim 1, wherein determining the appropriate light emission for the aerial display based on the physical location of the robotic vehicle with respect to the aerial display comprises:
obtaining, by the processor, a file comprising information corresponding to at least a portion of the aerial display;
mapping, by a processor, the portion of the aerial display onto physical space; and
determining the appropriate light emission for the aerial display based on the physical location of the robotic vehicle within the physical space.

7. The method of claim 6, wherein obtaining the file comprising information corresponding to at least a portion of the aerial display comprises retrieving the file from a memory of the robotic vehicle.

8. The method of claim 6, wherein obtaining the file comprising information corresponding to at least a portion of the aerial display comprises receiving the file via wireless communication.

9. The method of claim 6, wherein the at least a portion of the aerial display comprises the entire aerial display.

10. The method of claim 1, wherein determining an appropriate light emission for the aerial display based on the physical location of the robotic vehicle with respect to the aerial display comprises evaluating a mathematical equation that provides the appropriate light emission based on the physical location of the robotic vehicle.

11. The method of claim 1, wherein:
the aerial display is a frame of a video; and
the physical location of the robotic vehicle with respect to the aerial display corresponds to a position at a time relative to the frame of the video.

12. The method of claim 1, wherein adjusting a light emission of the light source of the robotic vehicle comprises adjusting one or more of:
a color of the light source of the robotic vehicle;
a brightness of the light source of the robotic vehicle; or
an intensity of the light source of the robotic vehicle.

13. The method of claim 1, further comprising:
identifying locations of one or more other robotic vehicles with respect to the aerial display;
determining whether another robotic vehicle is out of place within the aerial display; and
adjusting the physical location of the robotic vehicle based on locations of one or more other robotic vehicles within the aerial display in response to determining that another robotic vehicle is out of place within the aerial display.

14. A robotic vehicle, comprising:
a light source; and
a processor coupled to the light source and configured with processor-executable instructions to:
determine a physical location of the robotic vehicle with respect to an aerial display;
determine an appropriate light emission for the aerial display based on the physical location of the robotic vehicle with respect to the aerial display; and
adjust a light emission of the light source consistent with the determined appropriate light emission.

15. The robotic vehicle of claim 14, wherein the processor is further configured with processor-executable instructions to determine the physical location of the robotic vehicle with respect to the aerial display by determining a position of the robotic vehicle within an external coordinate system.

16. The robotic vehicle of claim 14, wherein the processor is further configured with processor-executable instructions to determine the physical location of the robotic vehicle with respect to the aerial display by determining a position of the robotic vehicle within an external coordinate system and a viewing angle of the robotic vehicle as seen by an observer.

17. The robotic vehicle of claim 14, wherein the processor is further configured with processor-executable instructions to determine the physical location of the robotic vehicle with respect to the aerial display by determining a relative position of the robotic vehicle relative to one or more other robotic vehicles.

18. The robotic vehicle of claim 14, wherein the processor is further configured with processor-executable instructions to determine the physical location of the robotic vehicle with respect to the aerial display by determining a relative position of the robotic vehicle relative to one or more other robotic vehicles and a viewing angle of the robotic vehicle as seen by an observer.

19. The robotic vehicle of claim 14, wherein the processor is further configured with processor-executable instructions to determine the appropriate light emission for the aerial display based on the physical location of the robotic vehicle with respect to the aerial display by:
obtaining a file comprising information corresponding to at least a portion of the aerial display;
mapping the at least a portion of the aerial display onto physical space; and
determining the appropriate light emission for the aerial display based on the physical location of the robotic vehicle within the physical space.

20. The robotic vehicle of claim 19, further comprising a memory coupled to the processor, wherein the processor is further configured with processor-executable instructions to obtain the file comprising information corresponding to the at least a portion of the aerial display by retrieving the file from the memory.

21. The robotic vehicle of claim 19, further comprising wireless communication circuitry coupled to the processor, wherein the processor is further configured with processor-executable instructions to obtain the file comprising information corresponding to a portion of the aerial display by receiving the file via the wireless communication circuitry.

22. The robotic vehicle of claim 14, wherein the processor is further configured with processor-executable instructions to determine the appropriate light emission for the aerial display based on the physical location of the robotic vehicle by evaluating a mathematical equation that provides the appropriate light emission based on the physical location of the robotic vehicle within the aerial display.

23. The robotic vehicle of claim 14, wherein the processor is further configured with processor-executable instructions to adjust the light emission of the light source of the robotic vehicle by adjusting one or more of:
a color of the light source of the robotic vehicle;
a brightness of the light source of the robotic vehicle; or
an intensity of the light source of the robotic vehicle.

24. The robotic vehicle of claim 14, wherein the processor is further configured with processor-executable instructions to:
identify locations of one or more other robotic vehicles within the aerial display;
determine whether another robotic vehicle is out of place within the aerial display; and
adjust the physical location of the robotic vehicle based on locations of the one or more other robotic vehicles within the aerial display in response to determining that another robotic vehicle is out of place within the aerial display.

25. A robotic vehicle, comprising:
a light source;
means for determining a physical location of the robotic vehicle with respect to an aerial display;
means for determining an appropriate light emission for the aerial display based on the physical location of the robotic vehicle with respect to the aerial display; and
means for adjusting a light emission of the light source consistent with the determined appropriate light emission.

26. A processing device for use in a robotic vehicle, wherein the processing device is configured to:
determine a physical location of the robotic vehicle with respect to an aerial display;
determine an appropriate light emission for the aerial display based on the physical location of the robotic vehicle with respect to the aerial display; and
adjust a light emission of a light source of the robotic vehicle consistent with the determined appropriate light emission.

27. The processing device of claim 26, wherein the processing device is further configured to determine the physical location of the robotic vehicle with respect to the aerial display by determining one or more of:
a position of the robotic vehicle within an external coordinate system;
a relative position of the robotic vehicle relative to one or more additional robotic vehicles; or
a viewing angle of the robotic vehicle as seen by an observer.

28. The processing device of claim 26, wherein the processing device is further configured to determine the appropriate light emission for the aerial display based on the physical location of the robotic vehicle with respect to the aerial display by:
obtaining a file comprising information corresponding to at least a portion of the aerial display;
mapping the portion of the aerial display onto physical space; and
determining the appropriate light emission for the aerial display based on the physical location of the robotic vehicle within the physical space.

29. The processing device of claim 26, wherein the processing device is further configured to adjust the light emission of the light source by adjusting one or more of:
a color of a light source of the robotic vehicle;
a brightness of the light source of the robotic vehicle; or
an intensity of the light source of the robotic vehicle.

30. The processing device of claim 26, wherein the processing device is further configured to:
identify locations of one or more other robotic vehicles with respect to the aerial display;
determine whether another robotic vehicle is out of place within the aerial display; and
adjust the physical location of the robotic vehicle based on locations of the one or more other robotic vehicles within the aerial display in response to determining that another robotic vehicle is out of place within the aerial display.
